(19) United States
(12) Patent Application Publication
(10) Pub. No.: US 2021/0232757 A1
(43) Pub. Date: Jul. 29, 2021

(54) COMPUTER-IMPLEMENTED SYSTEMS AND METHODS FOR PROCESSING AN ELECTRONIC DOCUMENT

(71) Applicant: COUPANG CORP., Seoul (KR)

(72) Inventors: Byoung In LIM, Seoul (KR); Jin Su Lee, Seoul (KR); Seon Ah Kim, Seoul (KR); Jun Young Mun, Seoul (KR); Suk Min Ahn, Seoul (KR)

(73) Assignee: Coupang Corp.

(21) Appl. No.: 16/776,007

(22) Filed: Jan. 29, 2020

(51) Int. Cl. G06F 40/166; G06F 21/60; G06F 11/30

(52) U.S. Cl. CPC G06F 40/166; G06F 11/302; G06F 11/3089; G06F 21/60

(57) ABSTRACT

Disclosed embodiments provide systems and methods for processing an electronic document. A method for processing an electronic document comprises receiving, from a user device, a fillable electronic document and a request for processing the fillable electronic document, using an authorization module to determine whether the received fillable electronic document can be processed, and uploading the received document by operating a first set of predefined processes based on an indicator attached to the received fillable electronic document. The method further comprises generating a complete electronic document based on a completion of the first set of predefined processes, operating a second set of processes on the generated complete electronic document, monitoring a first status of the first set of predefined processes and a second status of the second set of predefined processes, and providing the first monitored status and the second monitored status to the user device.

### TECHNICAL FIELD

The present disclosure generally relates to computerized systems and methods for processing an electronic document and monitoring the process. In particular, embodiments of the present disclosure relate to inventive and unconventional computer-implemented systems, methods, and user interfaces for processing an electronic document and monitoring the process by defining one or more processes.

### BACKGROUND

Electronic systems that allow for executing an electronic contract often require an accredited certificate and a plugin (such as ActiveX). For example, a user needs a computing device installed with a plugin and an accredited certificate to execute an electronic document. However, such requirements cause inconvenience, and are associate with limited system environments (e.g., requiring Internet Explorer browser using ActiveX plugins) and high cybersecurity threats. Moreover, electronic systems encounter a set of hardships in managing problems occurring on a set of processes operated for a complete electronic contract. The systems could not identify an erroneous process and a reason for failure. Thus the systems could not conveniently relaunch the failed process.

Therefore, there is a need for improved methods and systems for processing an electronic document and monitoring the process by defining one or more process and providing a user interface to monitor the process.

### SUMMARY

One aspect of the present disclosure is directed to a computer-implemented system for processing an electronic document and monitoring the process. The computer implemented system may include one or more memory devices storing instructions. The computer-implemented system may also include one or more processors configured to execute the instructions to perform operations. The operations may comprise receiving, from a user device, a fillable electronic document and a request for processing the fillable electronic document, using an authorization module to determine whether the received fillable electronic document can be processed, and uploading the received fillable document by operating a first set of predefined processes based on an indicator attached to the received fillable electronic document. The operations may further comprise monitoring a first status of the first set of predefined processes by reading indicators attached to each of the first set of predefined processes and providing the first monitored status to the user device based on a request from the user device.

Another aspect of the present disclosure is directed to a method for processing an electronic document and monitoring the process. The method may comprise receiving, from a user device, a fillable electronic document and a request for processing the fillable electronic document, using an authorization module to determine whether the received fillable electronic document can be processed, and uploading the received fillable document by operating a first set of predefined processes based on an indicator attached to the received fillable electronic document. The method may further comprise monitoring a first status of the first set of predefined processes by reading indicators attached to each of the first set of predefined processes and providing the first monitored status to the user device based on a request from the user device.

Yet another aspect of the present disclosure is directed to a computer-implemented system for processing an electronic document and monitoring the process. The computer implemented system may include one or more memory devices storing instructions. The computer-implemented system may also include one or more processors configured to execute the instructions to perform operations. The operations may comprise receiving, from a user device, a fillable electronic document and a request for processing the fillable electronic document, using an authorization module to determine whether the received fillable electronic document can be processed, and uploading the received document by operating a first set of predefined processes based on an indicator attached to the received fillable electronic document. The operations may further comprise generating a complete electronic document based on a completion of the first set of predefined processes, operating a second set of processes on the generated complete electronic document, monitoring a first status of the first set of predefined processes and a second status of the second set of predefined processes, and providing the first monitored status and the second monitored status to the user device.

Other systems, methods, and computer-readable media are also discussed herein.

### BRIEF DESCRIPTION OF THE DRAWINGS

FIG. 1 depicts a block diagram of an exemplary computer system, consistent with the disclosed embodiments.

FIG. 2 depicts a logical diagram of an exemplary system for defining, inserting, and digitizing attachment data, consistent with the disclosed embodiments.

FIG. 3A is an exemplary flow chart of process for processing an electronic document and monitoring the process, consistent with the disclosed embodiments.

FIG. 3B is a continuing exemplary flow chart of process for processing an electronic document and monitoring the process, consistent with the disclosed embodiments.

FIG. 3C is an exemplary flow chart of process for generating a complete electronic document, consistent with the disclosed embodiments.

FIG. 4 depicts an exemplary user interface of a user device displayed on web browser for monitoring one or more processes for each electronic document, consistent with the disclosed embodiments.

FIG. 5A is an exemplary flow chart of process for uploading an electronic document, consistent with the disclosed embodiments.

FIG. 5B is an exemplary flow chart of process for operating a set of processes, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for processing an electronic document and monitoring the process. The disclosed embodiments provide innovative technical features that allow defining one or more processes, processing an electronic document based on the defined processes, and monitoring the process. For example, the disclosed embodiments enable preparation of an interface for defining a first set of processes and a second set of processes, processing of an electronic document on the defined first set of processes based on an indicator attached to the electronic document, generation of a complete electronic document, operation of the defined second set of processes on the generated complete electronic document, and conveniently monitoring a status of the first set of processes and a status of the second set of processes.

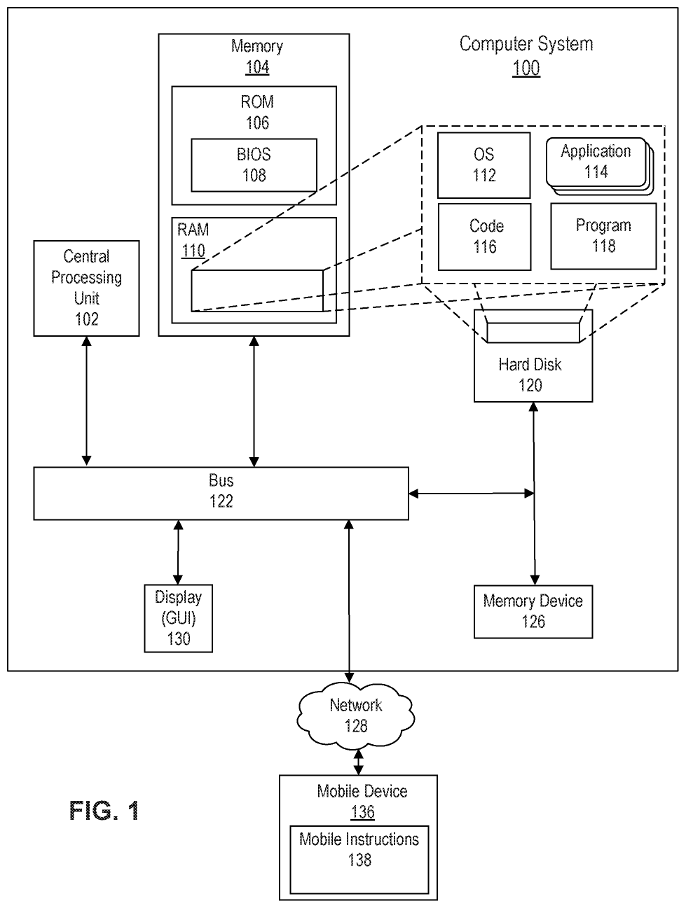

FIG. 1 depicts a block diagram of an exemplary computer system 100, consistent with disclosed embodiments. Components of system 100 may include a central processing unit (CPU) or processor 102, a memory unit 104, and a bus 122 that interconnects system components including memory 104 and CPU 102. Computer system 100 can include computer-readable media, such as volatile or nonvolatile computer storage media implemented in a method or technology suitable for storing computer-readable instructions, data structures, program modules, of the like (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other suitable medium).

Bus 122 can be a suitable type of bus structure, such as a memory bus or memory controller, a peripheral bus, and a local bus using a suitable bus architecture. By way of example, and not limitation, such architectures can include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus—also known as Mezzanine bus.

Memory 104 can include computer-readable media, such as read only memory (ROM) 106 and random access memory (RAM) 110. A basic input/output system (BIOS) 108, containing the basic routines that help to transfer information between elements within computer system 100 is typically stored in ROM 106. Additionally, RAM 110 may contain operating system (OS) 112, applications 114, other code 116 that may be executed by one or more different programs, and program 118. RAM 110 typically contains data and/or program modules that are immediately accessible to and/or presently being operated on by CPU 102.

Hard disk drive 120 can be removable/non-removable and volatile/nonvolatile computer media. The hard disk drive 120 can read from or write to non-removable, nonvolatile magnetic media, and a memory device 126. Other removable/non-removable and volatile/nonvolatile computer storage media that can be used in exemplary computer system 100 include, but are not limited to, magnetic tape cassettes, flash memory cards, digital versatile disks, digital video tape, solid state RAM, and solid state ROM. The disks and their associated computer media, discussed above and illustrated in FIG. 1, provide storage of computer-readable instructions, programmable code, data structures, program modules and other data for computer system 100. In FIG. 1, hard disk 120 is illustrated as storing an operating system (OS) 112, one or more applications 114, other programmable code 116, and a program 118.

Memory device 126 can be an optical disk drive or a magnetic disk drive that reads from or writes to a removable and nonvolatile storage medium such as an optical disk or magnetic disk.

A user can enter commands and information into computer system 100 through an input device such as a keyboard and mouse, trackball or touch pad tablet, electronic digitizer, or microphone. Other input devices can include a joystick, game pad, satellite dish, or scanner. These and other input devices can be connected to CPU 102 through an input interface that is coupled to bus 122, or through other interfaces or bus structures, such as a parallel port, game port or a universal serial bus (USB) (not pictured). A display (GUI) 130 or other type of video device can also be connected to bus 122 via an interface, such as a video interface. In addition, an output device, such as speakers or a printer, can be connected to bus 122 through an output interface.

Computer system 100 can operate in a networked environment using a network 128 and a mobile device 136. Mobile device 126 can be used by a user who wants to manipulate metadata incorporated in an attachment to an electronic document. Computer system 100 can also include a personal computer, a server, a router, a network PC, a peer device or other common network node. Mobile device 136 can include a handheld, tablet, or client device. Network 128 depicted in FIG. 1 can include a local area network (LAN), a wide area network (WAN), or other type of network. Such networking environments are commonplace in offices, enterprise-wide computer networks, intranets, and the Internet. In a networked environment, programmable code and application programs can be stored in remote computers. By way of example, FIG. 1 illustrates mobile instructions 138 as residing on mobile device 136. It will be appreciated that the network connections shown are exemplary and other means of establishing communication between computers and mobile device 136 can be used.

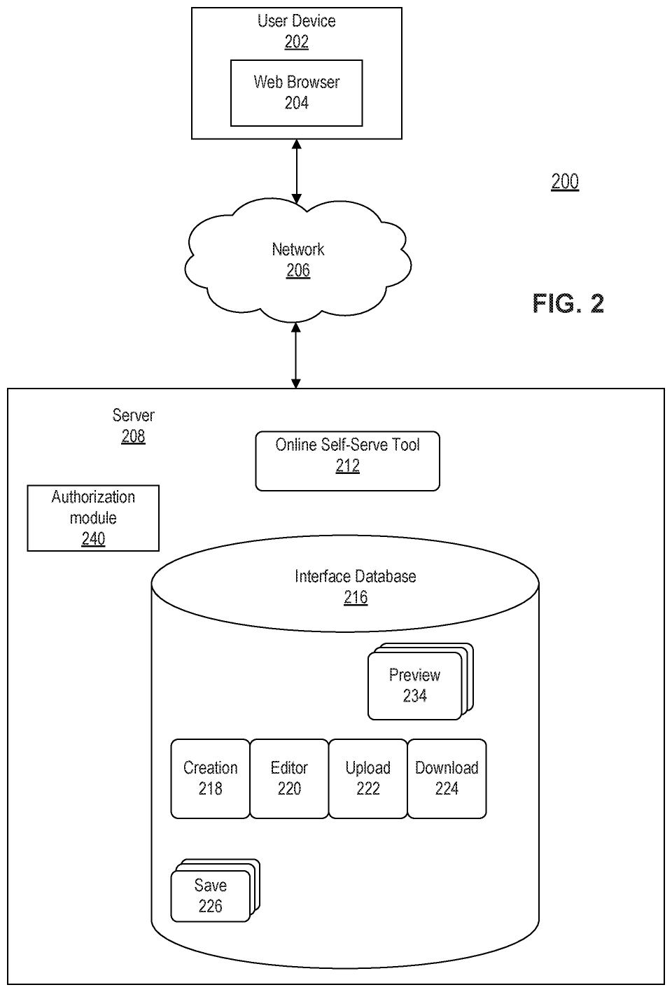

FIG. 2 depicts a logical diagram of an exemplary system for manipulating metadata incorporated attached to an electronic document, consistent with disclosed embodiments. In various embodiments, a user device 202 can be mobile device 136 or any other computing device, such as computer system 100 of FIG. 1. User device 202 can be operably coupled to one or more servers 208 by a network 206.

Network 206 can be a suitable network, such as a local area network (LAN), a wide area network (WAN), or other type of network. A web browser 204 can execute on computer 100 (as shown) or mobile device 136 (not shown), and web browser 204 can include functionality for receiving data entered at user device 202 as part of a self-serve tool consisting of a plurality of graphical user interfaces (GUIs). In general, web browser 204 can be implemented using interpreted or executable software code such as a kernel component, an application program, a script, a linked library, an object with methods, and so forth. The particular implementation of web browser 204 is not intended to be limiting. Web browser 204 can be configured to display interfaces, such as the interfaces described herein, for interacting with the disclosed system for manipulating metadata incorporated in an attachment of electronic document. As would be appreciated by those of skill in the art, additional interfaces may also be used to interact with the disclosed system.

Server 208 can be a suitable computer system or computing device, such as computer system 100 of FIG. 1. In some instances, server 208 can be part of a cloud computing platform. In various instances, server 208 can be configured to host at least one of online self-serve tool 212, interface database 216, or authorization module 240. Authorization module 240 may determine whether a received electronic document from user device 202 can be processed.

Interface database 216 can include a creation interface 218, an editor interface 220, an upload interface 222, and a download interface 224. Creation interface 218 may enable user device 202 to create a process, a file, or a document in interface database 216 and editor interface 220 may enable user to edit a process, a file or a document stored in interface database 216. Upload interface 222 may enable user device 202 to upload a process, a file or a document in interface database 216 and download interface 224 may enable user device 202 to download a process, a file or a document stored in interface database 216.

Interface database 216 can also include multiple save interfaces 226 and multiple preview interfaces 234. Save interfaces 226 may enable user device 202 to save a file or a document in interface database 216 and preview interfaces 234 may enable user device 202 to preview a file or document stored in interface database 216. Other interfaces (not shown) can be contemplated for display to user device 202 and for interacting with online self-serve tool 212. Each of the interfaces and associated modules for displaying the interfaces can include suitable executable software code such as a kernel component, an application program, a linked library, an object with methods, or other type of executable software code. User device 202 can utilize one or more of the interfaces to manipulate metadata.

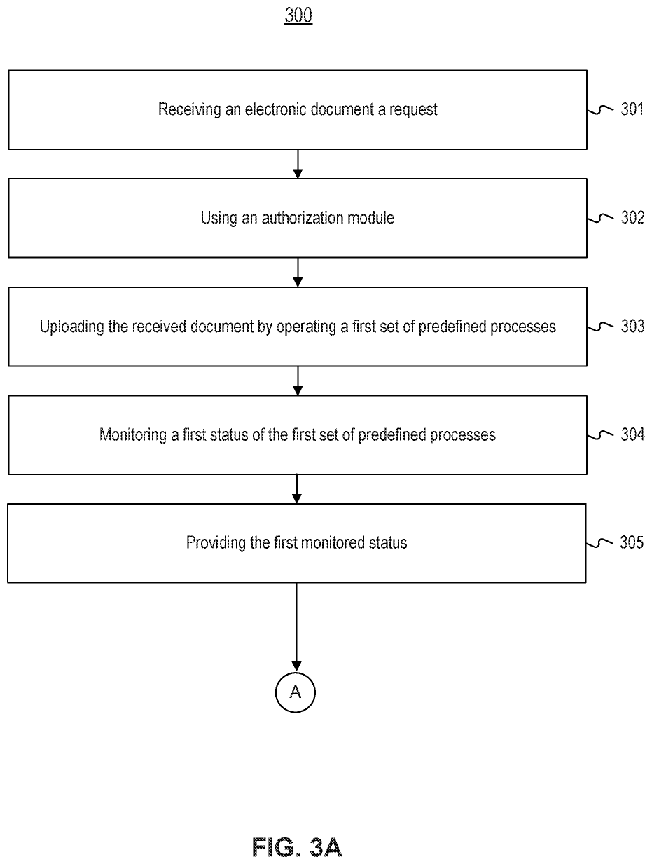

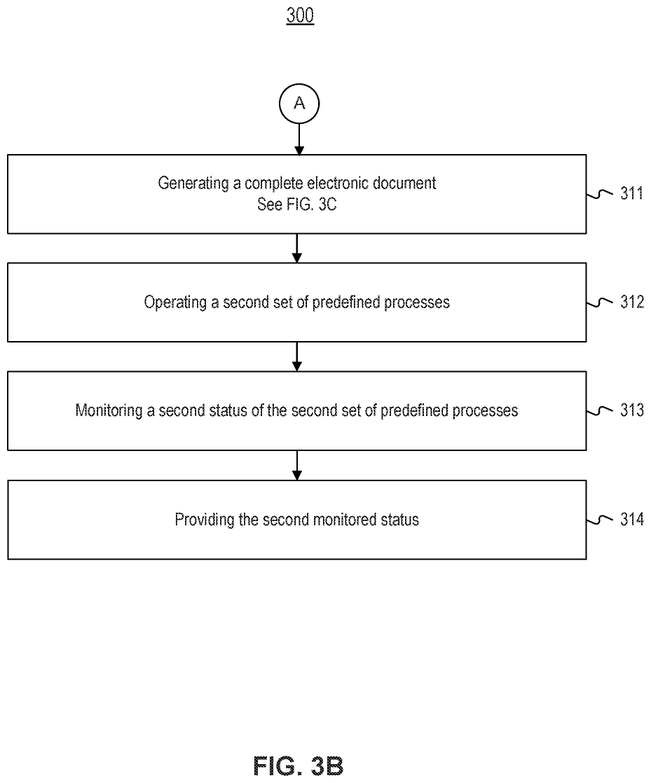

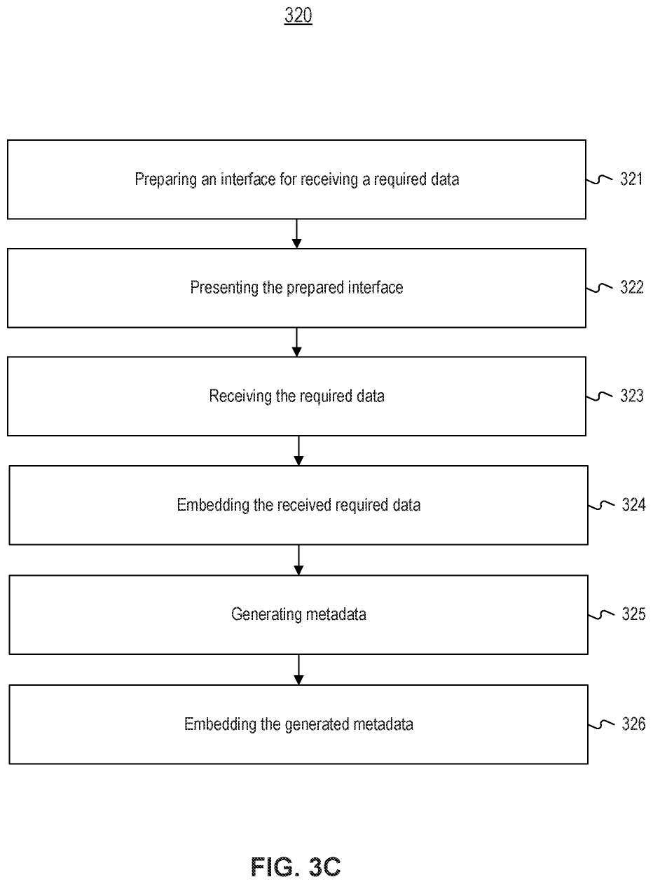

FIG. 3A is an exemplary flow chart of process 300 for processing an electronic document and monitoring the process, consistent with the disclosed embodiments. This exemplary method is provided by way of example. Method 300 shown in FIG. 3A can be executed or otherwise performed by server 208. Method 300 as described below may be carried out by server 208 by way of example. Each block shown in FIG. 3A represents one or more processes, methods, or subroutines in the exemplary method 300. Referring to FIG. 3A, exemplary method 300 may begin at block 301.

In step 301, server 208 may receive an electronic document and a request for processing the electronic document from user device 202. While user device 202 is referenced in explaining the method of FIG. 3A, it should be noted that devices with similar capacities and components of computer system 100 may carry out the method of FIG. 3A, as appropriate. User device 202 may use web browser 204 displayed on user device 202 to transmit the electronic document and the request for processing the electronic document. For example, web browser 204 may provide a user interface for requesting a process of an electronic document, and user device 202 may configure a control implemented in the user interface to request the process and transmit the electronic document. The control may be in the form of a button that a user associated with user device 202 can press or click the button to request the process and transmit the electronic document. In some embodiments, the electronic document is a contract.

In step 302, server 208 may use an authorization module 240 to determine whether the received electronic document from step 301 can be processed. Authorization module 240 can be configured to call an outside application programming interface or a commercial product to determine whether the received electronic document can be processed. In some embodiments, authorization module 240 may transmit the received electronic document to a second user device associated with a party of the contract to determine whether the received electronic document from step 301 can be processed. For example, when a user associated with user device 202 log in to server 208, authorization module 240 may check whether a person associated with a signature embedded in the received electronic document matches the user.

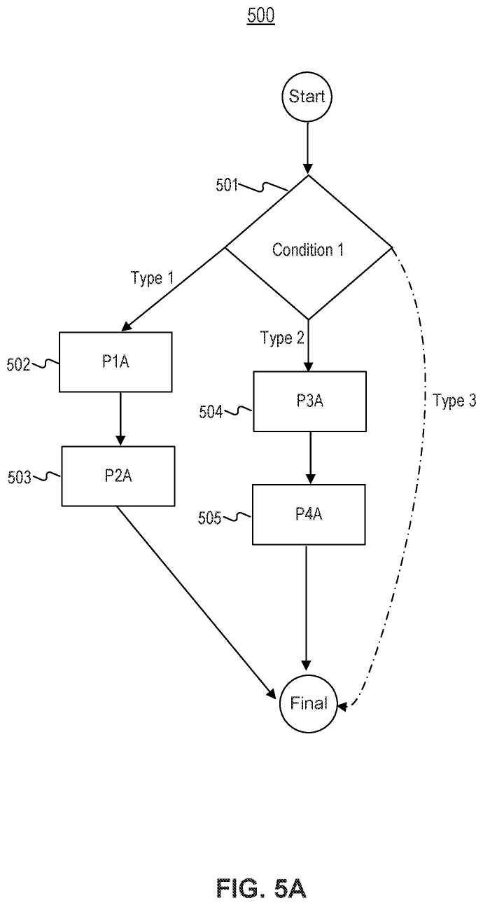

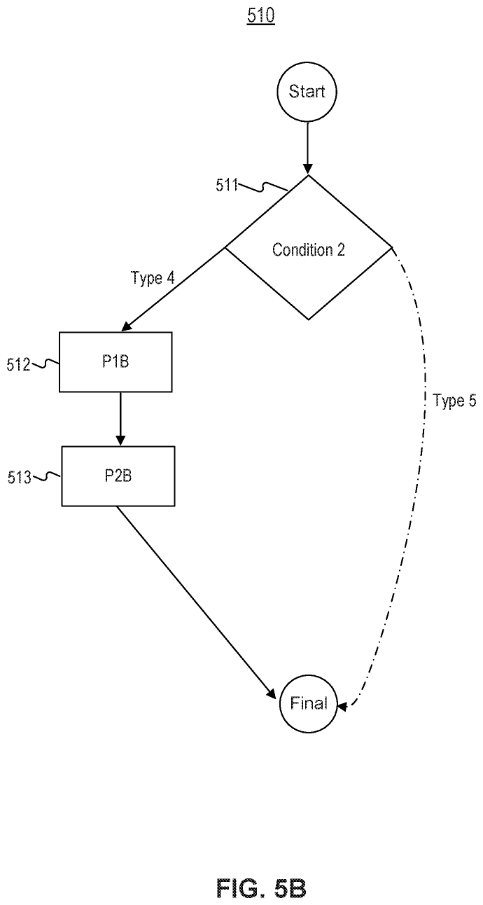

In step 303, server 208 may upload the received electronic document by operating a first set of predefined processes based on an indicator attached to the received electronic document. The first set of predefined processes can be defined using creation interface 218. In some embodiments, server 208 may prepare an interface for defining one or more processes. For example, exemplary interface 500 comprising four processes and one conditional node is illustrated in FIG. 5A. As shown in FIG. 5A, user associated with user device 202 may, using creation interface 218, define how processes can be operated on a received electronic document based on a conditional node. In the exemplary processes depicted in FIG. 5A, the received electronic document can be uploaded by operating first processes P1A and P2A, second processes P3A and P4A, or no processes based on its type determined by Condition 1. For example, Condition 1 may determine whether a contract signature type is electronic (Type 1) or manual (Type 2) by reading the attached indicator. When the contract signature type is electronic, server 208 may operate a first process P1A. The first process may comprise uploading the received electronic document in interface database 216. When the first process P1A is completed, server 208 may operate a second process P2A, wherein the second process may comprise uploading the received electronic document to a specific website storing electronic documents such as contracts. While FIG. 5A is directed to one set of processes, it is appreciated that the embodiments are not used to limit the present disclosure to specific set of processes.

In step 304, server 208 may monitor a first status of the first set of predefined processes. Server 208 may monitor the status by reading indicators attached to the predefined processes. For example, when a process is started, server 208 may attach a start indicator to the process and a finish indicator when the process is completed. If the process has not completed within a predefined time, server 208 may attach a failure indicator to the process. Server 208 may save the indicators in interface database 216 or a cache implemented in server 208 and access interface database 216 or the cache to read the indicators.

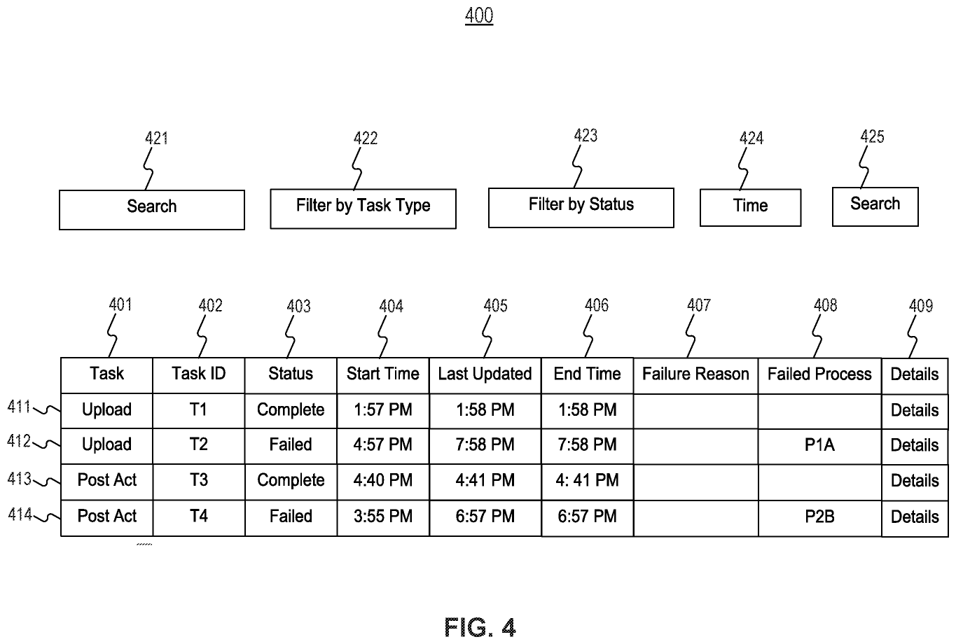

in step 305, server 208 may provide a list of the monitored first status to user device 202 based on its readings of attached indicators when server 208 receives a request from user device 202. For example, server 208 may provide exemplary interface 400 in FIG. 4 to user device 202. As shown in FIG. 4, server 208 is uploading first electronic document 411 and second electronic document 412 by operating a set of predefined processes for each electronic document 411 and 412. Exemplary interface 400 provides that electronic document 411 is completed without a failure while electronic document 412 failed with process P1A. User device 202 may request a list of the monitored first status by using interface 400 configured to filter processes based on inputs entered by user device 202. The use of interface 400 for filtering processes and requesting a list of filtered process is illustrated in FIG. 4 and will be discussed in more detail.

When the first set of predefined processes are completed, server 208, in step 311 (depicted in FIG. 3B) may generate a complete electronic document. Step 311 is further described with respect to step 321 in FIG. 3C. In step 321 (FIG. 3C), server 208 may prepare an interface for receiving a required data. The required data may be a signature needed to execute an electronic document such as contract. The interface may comprise one or more inputs configured capture required data.

In step 322, server 208 may present the user interface prepared in step 321 within a web browser 204 in a second user device. A user associated with the second user device 202 may use a web browser displayed on the second user device to enter required data in the user interface. Server 208 may also present the user interface prepared in step 321 within a web browser 204 in user device 202. A user associated with user device 202 may use web browser 204 displayed on the user device 202 to enter a required data in the user interface. After entering the required data, the second user device or user device 202 may transmit the entered data to the server 208. For example, a user associated with user device 202 may configure a control implemented in the user interface to transmit required data to server 208. The control may be in the form of a button or a selectable element that user can press or click to transmit the required data.

In step 323, server 208 may receive the required data from the interface presented in step 322 transmitted from the user device 202. Exemplary required data can be signatures.

In step 324, server 208 may embed the received required data into the electronic document. For example, the required data may be a signature and server 208 may place the signature in specific pages needing the signature in the electronic document. The signature can be placed in the electronic document as an image or a text. Server 208 may use a digital signature to secure the signature.

In step 325, server 208 may generate metadata comprising one or more attributes. The attributes may comprise IP address associated with the user, a history of changes made on the electronic document by any users, a category of the electronic document and any suitable attributes describing the electronic document. In step 326, server 208 may embed the generated metadata to the electronic document. For example, server 208 may link a generated metadata to an electronic document.

After finishing completing the electronic document in step 325 in FIG. 3C, the process may go back to step 312 (in FIG. 3B). In step 312, server 208 may operate a second set of predefined processes on the electronic document. The second set of predefined processes can be defined using creation interface 218. The second set of predefined processes can be referred to as “post” actions. The electronic document may comprise, in some embodiments, one or more various agreements with vendors comprising signatures. Various processes can be operated on the electronic document based on the type of agreements. For example, processes may comprise integrating information related to settlement or information obtained via a rebate agreement, creating promotions or coupons based on agreements, or the like. Thus, server 208 may automate processes, such as downloading a promotion application programming interface, downloading warehouse management system billing application programming interface, etc., by calling an application programming interface that reduce human labor, lead time and, human faults. In some embodiments, server 208 may prepare an interface for defining one or more processes. For example, exemplary interface 510 comprising two processes and one conditional node is illustrated in FIG. 5B. As shown in FIG. 5B, user associated with user device 202 may, using creation interface 218, define how processes can be operated on a received electronic document based on a conditional node. In the exemplary processes depicted in FIG. 5B, the generated complete electronic document can be processed by operating first processes P1B and P2B or no processes based on a condition determined by Condition 2. For example, Condition 2 may determine whether a contract category is download (Type 4) by reading the embedded metadata. When the contract category is download, server 208 may operate a first process P1B. The first process may comprise downloading a promotion application programming interface. When the first process P1B is completed, server 208 may operate a second process P2B, wherein the second process may comprise downloading warehouse management system billing application programming interface. While FIG. 5B is directed to one set of processes, it is appreciated that the embodiments are not used to limit the present disclosure to specific set of processes.

In step 313, server 208 may monitor a second status of the second set of predefined processes. Server 208 may monitor the status by reading indicators attached to the predefined processes. For example, when a process is started, server 208 may attach a start indicator to the process and a finish indicator when the process is completed. If the process has not completed within a predefined time, server 208 may attach a failure indicator to the process. Server 208 may save the indicators in interface database 216 or a cache implemented in server 208 and access interface database 216 or the cache to read the indicators.

In step 314, server 208 may provide a list of the monitored second status to user device 202 based on its readings of attached indicators when server 208 receives a request from user device 202. For example, server 208 may provide exemplary interface 400 in FIG. 4 to user device 202. As shown in FIG. 4, server 208 is performing post actions (a second set of predefined process) on third electronic document 413 and fourth electronic document 414 by operating a set of predefined processes for each electronic document 413 and 414. Exemplary interface 400 provides that electronic document 413 is completed without a failure while electronic document 414 failed with process P2B. User device 202 may request a list of the monitored second status by using interface 400 configured to filter processes based on inputs entered by user device 202. The use of interface 400 for filtering processes and requesting a list of filtered process is illustrated in FIG. 4 and will be discussed in more detail.

FIG. 4 depicts an exemplary user interface 400 of a user device 202 displayed on web browser 204 for monitoring one or more processes for each electronic document, consistent with the disclosed embodiment. User interface 400 may comprise indicators 401-408 and button 409. In the exemplary user interface 400, four electronic documents 411-414 are depicted by way of example, but it is appreciated that any number of electronic documents can be monitored.

Indicator 401 may provide a task for each electronic document and indicator 402 may provide a task ID associated with task 401. For example, as shown in FIG. 4, electronic documents 411 and 412 are associated with uploading task (described in step 303 in FIG. 3A) provided by indicator 401 and associated with task ID T1 and T2, respectively. By way of further example, electronic documents 413 and 414 are associated with post action task (described in step 312 in FIG. 3B) provided by indicator 401 and associated with task ID T3 and T4, respectively. Indicator 403 may provide a status of task 401 associated with an electronic document. For example, as shown in FIG. 4, upload task for electronic document 411 is complete and upload task for electronic document 412 failed as provided by indicator 403. By way of further example, post action task for electronic document 413 is complete and post action task for electronic document 414 failed as provided by indicator 403. Indicators 404-406 may provide time associated with a task. For example, indicator 404 may provide a start time for each task, indicator 405 may provide a last updated time for each task, and indicator 406 may provide an end time for each task.

Indicator 407 may provide a failure reason for each task. The failure reason may comprise two types. A first type may arise from a failure from environmental factors. For example, a failure from environmental factors may comprise a disconnection caused by when an allowed network time expired, an incident from external solution, etc. A second type may arise from data inconsistency. For example, a request can be too large and data input can be inappropriate. Indicator 407 may enable user device 202 to identify and fix such causes by checking the failure reason in detail. Indicator 408 may provide a failed process. For example, as shown in FIG. 4, upload task for electronic document 412 fails with process P1A (depicted in FIG. 5A). By way of further example, post action task (a task from a second set of predefined processes) for electronic document 414 fails with process P2B (depicted in FIG. 5B). Button 409 may provide details of each task. For example, when button 409 receives a press or click to request details of task T2 associated with electronic document 412, server 208 may generate an interface similar to exemplary interface 500 in FIG. 5A and highlight process P1A to emphasize that process P1A has failed. By way of further example, when button 409 receives a press or click to request details of task T4 associated with electronic document 414, server 208 may generate an interface similar to exemplary interface 510 in FIG. 5B and highlight process P2B to emphasize that process P1A has failed.

User interface 400 may also comprise bars 421-424 and a button 425. Bar 421 may enable a user associated with user device 202 to enter a string to search a task. Bar 422 may enable a user associated with user device 202 to filter a task by its type. Bar 423 may enable a user associated with user device 202 to filter a task by its status. Bar 424 may enable a user associated with user device 202 to filter a task by time. For example, if a user enters 4 in bar 424, server 208 may filter and display tasks created within past four hours. Button 425 may filter and display electronic documents based on criteria entered in one or more of bars 421-424.

FIG. 5A is an exemplary flow chart of process 500 for uploading an electronic document, consistent with the disclosed embodiments. As discussed above with respect to step 303 in FIG. 3A, a user associated with user device 202 may design process 500 comprising one or more conditional nodes and one or more processes. In the exemplary process 500, a user implemented a conditional node 501 and processes P1A and P2A that are operated when Type 1 is determined on an electronic document by conditional node 501 and processes P3A and P4A are operated when Type 2 is determined on an electronic document by conditional node 501. No processes can be operated when Type 3 is determined on an electronic document. Exemplary processes for processes P1A, P2A, P3A, and P4A are uploading the received electronic document in interface database 216, uploading the received electronic document to a specific website storing electronic documents such as contracts, transmitting the received electronic document to a user device to receive a signature manually, and receiving the updated electronic document from the user device. In some embodiments, Type 1 can be electronic and Type 2 can be manual. While FIG. 5A is directed to one set of processes, it is appreciated that the embodiments are not used to limit the present disclosure to specific set of processes.

FIG. 5B is an exemplary flow chart of process 510 for operating a set of processes, consistent with the disclosed embodiments. As discussed above with respect to step 312 in FIG. 3B, a user associated with user device 202 may design process 510 comprising one or more conditional nodes and one or more processes. In the exemplary process 510, a user implemented a conditional node 511 and processes P1B and P2BA that are operated when Type 4 is determined on an electronic document by conditional node 511 and no processes are operated when Type 5 is determined on the electronic document. Exemplary processes for processes P1B and P2B are downloading a promotion application programming interface (API) and downloading a warehouse management system billing application programming interface (WMS_Billing API). For example, P1B may call promotion API for a creation of promotion. When the task (the creation of promotion) is successfully completed, P2B may call WMS_Billing API to send settlement information in the agreement to server 208 to enable automatic settlement. While FIG. 5B is directed to one set of processes, it is appreciated that the embodiments are not used to limit the present disclosure to specific set of processes.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for processing an electronic document and monitoring the process, comprising:
one or more memory devices storing instructions; and
one or more processors configured to execute the instructions to perform operations comprising:
receiving, from a user device, a fillable electronic document and a request for processing the fillable electronic document;
using an authorization module to determine whether the received fillable electronic document can be processed;
receiving a first set of defined processes from a user via a user interface;
uploading the received fillable electronic document by operating the received first set of defined processes based on an indicator attached to the received fillable electronic document, wherein the indicator comprises a type of agreement associated with the received fillable electronic document;
monitoring a first status of the first set of defined processes by reading indicators attached to each of the first set of defined processes; and
providing a list of the first monitored status to the user device based on a request from the user device.

2. The computer-implemented system of claim 1, wherein the operations further comprise:
generating a complete electronic document based on a completion of the first set of defined processes;
operating a second set of predefined processes on the generated complete electronic document;
monitoring a second status of the second set of predefined processes; and
providing the second monitored status to the user device.

3. The computer-implemented system of claim 2, wherein the provided second monitored status visualizes which of the second set of predefined processes halts a completion of the second set of predefined processes.

4. The computer-implemented system of claim 2, wherein generating a complete electronic document comprises:
preparing an interface for receiving a required data;
presenting the prepared interface within a web browser in a second user device;
receiving the required data from the second user device; and
embedding the received required data to the fillable electronic document by inserting the received required data into specific pages needing the required data in the fillable electronic document.

5. The computer-implemented system of claim 4, wherein the required data is a signature received from the second user device.

6. The computer-implemented system of claim 4, wherein generating a complete electronic document further comprises:
generating metadata comprising one or more attributes; and
embedding the generated metadata into the electronic document by linking the generated metadata to the complete electronic document.

7. The computer-implemented system of claim 6, wherein the attribute comprises an IP address associated with the user device.

8. The computer-implemented system of claim 6, wherein the attribute comprises a history of changes made on the electronic document by any users.

9. The computer-implemented system of claim 1, wherein the authorization module is configured to call an outside application programming interface or a commercial product to determine whether the received electronic document can be processed.

10. The computer-implemented system of claim 1, wherein the attached indicator comprises electronic and manual.

11. A method for processing an electronic document and monitoring the process, comprising:
receiving, from a user device, a fillable electronic document and a request for processing the fillable electronic document;
using an authorization module to determine whether the received fillable electronic document can be processed;
receiving a first set of defined processes from a user via a user interface;
uploading the received fillable electronic document by operating the received first set of defined processes based on an indicator attached to the received electronic document, wherein the indicator comprises a type of agreement associated with the received fillable electronic document;
monitoring a first status of the first set of defined processes by reading indicators attached to each of the first set of defined processes; and
providing a list of the first monitored status to the user device based on a request from the user device.

12. The method of claim 11, wherein the operations further comprise:
generating a complete electronic document based on a completion of the first set of defined processes;
operating a second set of predefined processes on the generated complete electronic document;
monitoring a second status of the second set of predefined processes; and
providing the second monitored status to the user device.

13. The method of claim 12, wherein the provided second monitored status visualizes which of the second set of predefined processes halts a completion of the second set of predefined processes.

14. The method of claim 12, wherein the generating a complete electronic document comprises:
preparing an interface for receiving a required data;
presenting the prepared interface within a web browser in a second user device;
receiving the required data from the second user device; and
embedding the received required data to the fillable electronic document by inserting the received required data into specific pages needing the required data in the fillable electronic document.

15. The method of claim 14, wherein the required data is a signature received from the second user device.

16. The method of claim 14, wherein the generating a complete electronic document further comprises:
generating metadata comprising one or more attributes; and
embedding the generated metadata into the electronic document by linking the generated metadata to the complete electronic document.

17. The method of claim 16, wherein the attribute comprises an IP address associated with the user device.

18. The method of claim 16, wherein the attribute comprises a history of changes made on the electronic document by any users.

19. The method of claim 11, wherein the authorization module is configured to call an outside application programming interface or a commercial product to determine whether the received electronic document can be processed.

20. A computer-implemented system for processing an electronic document and monitoring the process, comprising:
one or more memory devices storing instructions; and
one or more processors configured to execute the instructions to perform operations comprising:
receiving, from a user device, a fillable electronic document and a request for processing the fillable electronic document;
using an authorization module to determine whether the received fillable electronic document can be processed;
receiving a first set of defined processes from a user via a user interface;
uploading the received fillable electronic document by operating the received first set of defined processes based on an indicator attached to the received fillable electronic document, wherein the indicator comprises a type of agreement associated with the received fillable electronic document;
generating a complete electronic document based on a completion of the first set of defined processes;
operating a second set of processes on the generated complete electronic document;
monitoring a first status of the first set of defined processes and a second status of the second set of processes by reading indicators attached to each of the first set of defined process and the second set of processes; and
providing the first monitored status and the second monitored status to the user device based on a request from the user device.
